(19) United States
(12) Patent Application Publication
(10) Pub. No.: US 2004/0089684 A1
(43) Pub. Date: May 13, 2004

(54) Confection enclosure and ring

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Clyde I. Coughenour, 16607 Sutton Place, Woodbridge, VA, 22191, US

(21) Appl. No.: 10/288,923

(22) Filed: Nov. 7, 2002

(51) Int. Cl. A23B 4/00

(52) U.S. Cl. 224/237

(57) ABSTRACT

A portable confection container is provided with a ring for transport. A lid and housing confine the confection to prevent contamination during transport and storage. The lid and housing are releasably secured together with the confection secured to either the lid or housing. Optionally, the housing can be reversed and attached to the lid so as to expose the confection. Indicia on the lid with the ring can be aesthetically used independent from the housing or with the housing for miscellaneous item storage after the confection is consumed.

### BACKGROUND OF THE INVENTION

1. Field of the Invention

A confection is housed within a container provided with a housing, a lid and a ring such that separation of the housing and lid exposes the confection for consumption and connection of the lid and housing prevent contamination.

2. Description of Related Art

The consumption of hard and semi-solid confections has been common for many years. The confections are typically protected by a paper or foil wrapper, whether on a stick or not. In many instances, and particularly so when consumed by children, the entire confection is not consumed or is dropped and contaminated when not completely consumed, the confection is either unnecessarily thrown away or wrapped in the same or a new paper or foil for storage. The wrapping of a partially consumed confection typically results in the sticky surface of the confection tightly sticking to the wrapper. It is difficult to remove such a wrapper. During consumption, the sticky confection will smudge and soil any surface it contacts and will usually become contaminated by any surface contacted.

The combination of rings and other articles and confections is old. W. Parker, U.S. Des 229,522, issued Dec. 11, 1973, makes a ring of candy. A. Shorin et al, U.S. Des 242,645 and U.S. Des 242,646, issued Dec. 7, 1976, teach a ring having a matrix for supporting candy and a ring with candy respectively. S. Coleman, U.S. Pat. No. 219, 445, issued Sep. 9, 1879, teaches a ring having a spring-loaded closure for a compartment for housing matches supported on a ring. C. Bull, U.S. Pat. No. 5,732,862, issued Mar. 31, 1998, teaches a ring that removably supports a container for holding dental materials.

### SUMMARY OF THE INVENTION

A confection is housed within a covered container having a lid for preventing contamination of the confection. The housing or lid is provided with a ring for slipping over a finger for convenience and transport. The lid can be removed from the container, part of the confection consumed, and the lid reapplied for transport, storage, and contamination free later consumption.

### BRIEF DESCRIPTION OF THE DRAWINGS

FIGS. 1 and 2 are exploded side views of the confection containing ring with the lid shown separated.

FIG. 3 is an exploded side view of a second embodiment of the confection containing ring with the ring supporting confection separated from the cover.

FIG. 4 is an exploded side view of a third embodiment of the confection containing ring with the confection containing housing separated from the ringed lid.

FIG. 5 is a partial sectional view of a lid and housing attachment.

### DESCRIPTION OF THE PREFERRED EMBODIMENTS

The present confection housing ring is for conveniently transporting protecting and consuming the confection. The ring can be secured to the lid or housing. The confection can easily be placed on a finger and carried around until it is desired to consume the confection. The confection is consumed by simply separating the lid from the housing and licking the confection. Any remaining confection can be kept safe and free from contamination until it is desired to consume more of it by simply joining the lid and housing.

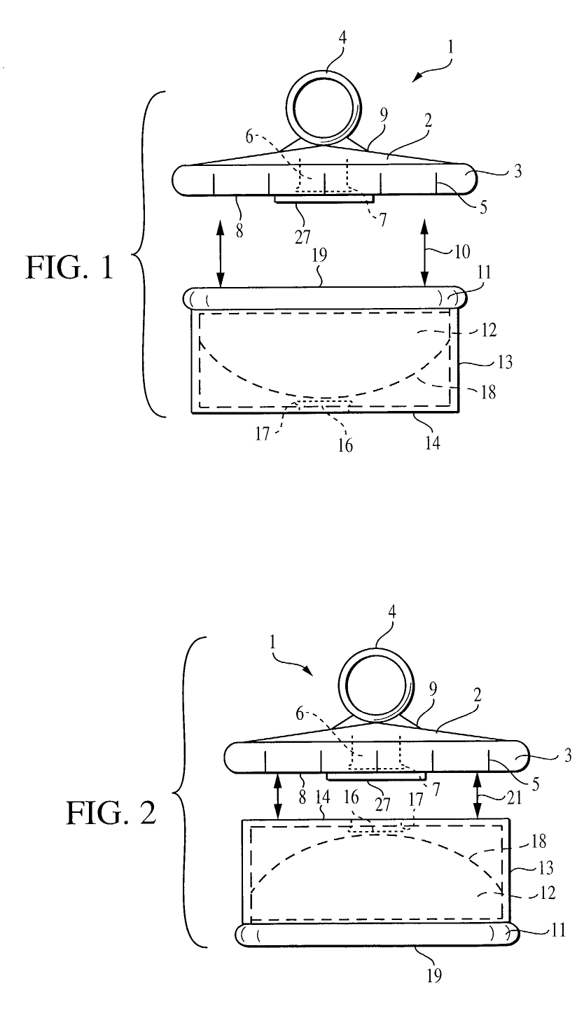

Vertically the confection housing ring 1 of FIG. 1 shows the lid 2 separated from the housing 13. The lid has a ring 4 secured to the top or outer end of the lid and an arcuate rim 3 around the base of or inner end of the lid. The arcuate rim is provided with slits 5 around its length to provide lines of weakness so that the arcuate rim can be sprung outwardly when pressure is applied. A protrusion 6 is provided centrally under or within the lid with a lip 7 around its terminal end. The housing 13 provides an arcuate base 18 within the housing for supporting the confection 12. The inner end 19 of the housing is provided with an arcuate rim 11 that is slightly smaller than the arcuate rim 3 of the lid. The outer end 14 of the housing has a centrally positioned recess 16 with a groove 17 around its terminal end. In its on finger portable configuration, the base 8 of the lid 2 is pressed 10 onto the housing inner end 19 where the arcuate rim 3 of the lid snaps over the arcuate rim 11 of the housing 13 where it seals the lid to the housing where it remains until use.

To consume the confection 12, the lid 2 is pulled away 10 from the housing. The slits 5 in the arcuate non-resilient rim 3 act as lines of weakness and give the arcuate rim 3 a spring like quality enabling the rim 3 to be removed from the slightly smaller arcuate rim 11. With the lid removed from the housing 13, the confection 12 can be licked and consumed by extending the tongue through the open housing inner end 19. The protrusion 6 within the lid 2 can be pressed 21 into the recess 16 in the housing as indicated in FIG. 2. The outer end 14 of the housing fits within the arcuate rim 3, and the inner end 8 of the lid. The lip 7 on the protrusion 6 slips into the groove 17 at the base of the recess 16 to removably secure the lid 2 to the housing outer end 14. With the lid secured to the housing outer end, the confection is exposed through the housing open inner end 19 while the confection housing ring is positioned on a finger. After the consumer is finished, the remaining confection can again be sealed by pulling 21 the lid protrusion 6 from the housing outer end recess 16 and pressing the lid arcuate rim 3 over the housing arcuate rim 11.

The inner end 8 of the lid 2 is provided with indicia such as a hologram or graphic image 27 so that the lid can be used as an aesthetic ring independent of the housing when the confection is consumed as well as a means for housing other objects with use of the empty housing 13 attached to the lid.

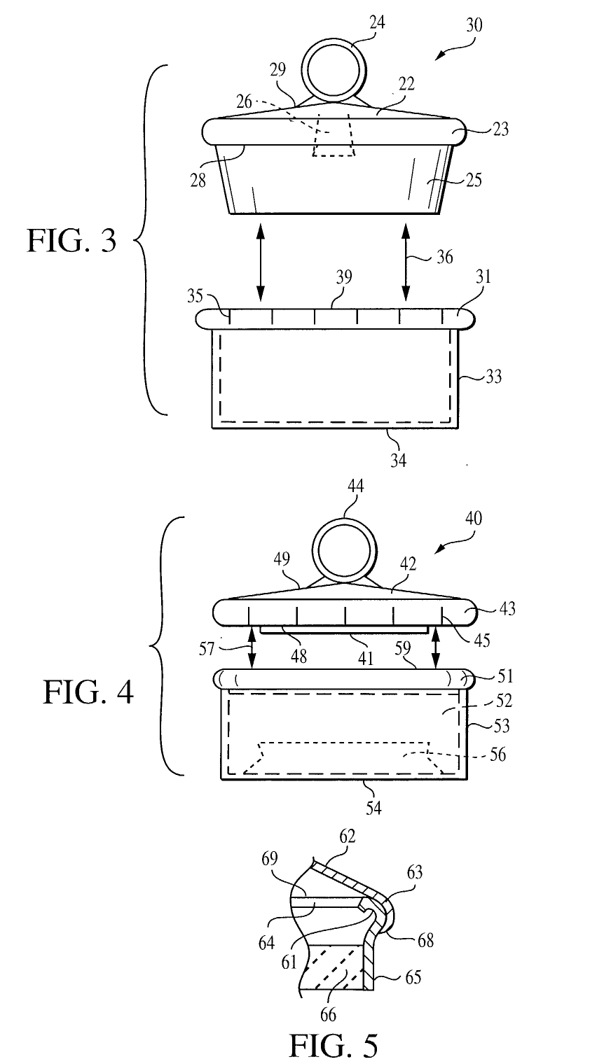

FIG. 3 is a modification of the confection containing ring of FIGS. 1 and 2. The lid 22 has a ring 24 on its outer end 29 and an arcuate rim 23, similar to that of FIGS. 1 and 2, on its inner end 28, except that the rim 23 does not have slits. The confection 25 is held under the lid 22 using a matrix 26 to secure it in place. The confection extends beyond the lid base 28. The housing 33 is hollow for receiving the confection 25 for storage and transport. The housing inner end 39 has an arcuate rim 31 provided with slits 35. The arcuate rim 23 of the lid is slightly smaller than the arcuate rim 31 of the housing. By pressing 36 the lid and housing together, the arcuate rim 31 of the housing snaps over the arcuate rim 23 of the lid for sealing, transport and/or storage. By pulling 36 the lid 22 and housing 33 apart, the confection is exposed for consumption. The confection can be consumed while the lid is held on a finger by the ring 24, without the necessity to remove the ring from the finger used for transport.

FIG. 4 is a further modification of the confection containing ring of FIGS. 1 and 2. The lid 42 has ring 44 secured to the top or outer end 49 of the lid with an arcuate rim 43 having slits 45 on its inner end 48 as in FIGS. 1 and 2. The housing 53 contains the confection 52 being held within the housing by matrix 56 on the inner side of the outer end 54 of the housing. The inner end of the housing 59 is provided with an arcuate rim 51 that is slightly smaller than the lid arcuate rim 43. By pressing 57 the lid 42 against the housing 53, the housing arcuate rim 51 and the lid arcuate rim 43 snap together to seal and secure the two together. By pulling 57 the lid and housing apart, the two are separated. The confection 52 can then be consumed by licking the confection through the open housing inner end 59. After a consumption of some of the confection, the remaining portion can be sealed within the housing by pressing 57 the lid back onto the housing. The lid inner end 48 is provided with indicia such as a hologram or graphic image 41 so the lid can be worn as an aesthetic ring independent of the housing.

The horizontal shape of the lid and housing is optional. They can be circular, oval or have flat sides that match. The housing and or lid can be constructed of metal or plastic. They are preferably large enough to avoid accidental swallowing. FIG. 5 is a partial sectional view of a slit arcuate rim 63 inner end 68 held in place over an arcuate rim 61 for holding and sealing one component 62, for example a lid, onto a second component 65, for example a housing. The connection seals and protects any confection held between the two. Any confection 66 within the housing 65 is exposed through the opening 64 at the housing inner end 69.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A confection housing ring comprising:
a lid having an outer end and an inner end;
a housing having an outer end and an inner end;
a ring for supporting said lid and housing on a finger;
a confection;
a means for securing said confection between said lid outer end and said housing outer end;
means for releasably securing said lid inner end to said housing inner end for sealing said confection between said lid outer end and said housing outer end against contamination.

2. A confection housing ring as in claim 1 wherein:
said means for releasably securing said lid inner end to said housing inner end includes an arcuate rim on said lid inner end and an arcuate rim on said housing inner end.

3. A confection housing ring as in claim 2 wherein:
said arcuate rim on said lid inner end is slightly larger than said arcuate rim on said housing inner end;
said arcuate rim on said lid inner end has vertical slits to render said lid arcuate rim resilient.

4. A confection housing ring as in claim 2 wherein:
said arcuate rim on said housing inner end is slightly larger than said arcuate rim on said lid inner end;
said arcuate rim on said housing inner end has vertical slits to render said housing arcuate rim resilient.

5. A confection housing ring as in claim 1 wherein:
said ring is secured to said lid outer end.

6. A confection housing ring as in claim 5 wherein:
said lid inner end is provided with indicia so that the lid can be used independently as an aesthetic ring.

7. A confection housing ring as in claim 1 wherein:
said confection is secured to said lid by a matrix and extends from said lid outer end toward said lid inner end.

8. A confection housing ring as in claim 7 wherein:
said confection protrudes inwardly beyond said lid inner end.

9. A confection housing ring as in claim 8 wherein:
said housing has a hollow interior for reception of said protruding confection.

10. A confection housing ring as in claim 1 wherein:
said confection is secured within said housing for consumption through a housing open inner end.

11. A confection housing ring as in claim 10 wherein:
said confection is secured within said housing using a matrix affixed to said housing outer end.

12. A confection housing ring as in claim 10 wherein:
said confection is secured within said housing using an arcuate confection support.

13. A confection housing ring as in claim 1 wherein:
said lid is provided with a lid protrusion that extends from said lid outer end to said lid inner end;
said housing outer end is provided with a housing recess;
said lid inner end is securable to said housing outer end by inserting said lid protrusion into said housing recess.

14. A confection housing ring as in claim 13 wherein:
said lid protrusion outer end has a lip around it and said housing recess has a groove around it for releasably locking said lid and said housing together.

15. A confection housing ring as in claim 14 wherein:
said means for releasably securing said lid inner end to said housing inner end includes an arcuate rim on said lid inner end and an arcuate rim on said housing inner end;
said arcuate rim on said lid inner end is slightly larger than said arcuate rim on said housing inner end;
said arcuate rim on said lid inner end has vertical slits to render said lid arcuate rim resilient;
said ring is secured to said lid outer end.

16. A confection housing ring as in claim 15 wherein:
said confection is secured within said housing using an arcuate confection support.

17. A confection housing ring as in claim 8 wherein:
said means for releasably securing said lid inner end to said housing inner end includes an arcuate rim on said lid inner end and an arcuate rim on said housing inner end;
said arcuate rim on said housing inner end is slightly larger than said arcuate rim on said lid inner end;
said arcuate rim on said housing inner end has vertical slits to render said housing arcuate rim resilient.

18. A confection housing ring as in claim 11 wherein:
said means for releasably securing said lid inner end to said housing inner end includes an arcuate rim on said lid inner end and an arcuate rim on said housing inner end;
said arcuate rim on said lid inner end is slightly larger than said arcuate rim on said housing inner end;
said arcuate rim on said lid inner end has vertical slits to render said lid arcuate rim resilient;
said ring is secured to said lid outer end.

19. A confection housing ring as in claim 12 wherein:
said means for releasably securing said lid inner end to said housing inner end includes an arcuate rim on said lid inner end and an arcuate rim on said housing inner end;
said arcuate rim on said lid inner end is slightly larger than said arcuate rim on said housing inner end;
said arcuate rim on said lid inner end has vertical slits to render said lid arcuate rim resilient;
said ring is secured to said lid outer end;
said lid is provided with a protrusion that extends from said lid outer end to said lid inner end;
said housing outer end is provided with a recess;
said lid inner end is securable to said housing outer end by inserting said lid protrusion into said housing recess;
said lid protrusion outer end has a lip around it and said housing recess has a groove around it for releasably locking said lid and said housing together.

20. A confection housing ring as in claim 6 wherein:
said indicia is in the form of a hologram.
